(19) United States
(12) Patent Application Publication
(10) Pub. No.: US 2016/0021369 A1
(43) Pub. Date: Jan. 21, 2016

(54) VIDEO CODING INCLUDING A STAGE-INTERDEPENDENT MULTI-STAGE BUTTERFLY INTEGER TRANSFORM

(71) Applicant: Shreyas HAMPALI, Bangalore (IN)

(72) Inventor: Shreyas HAMPALI, Bangalore (IN)

(21) Appl. No.: 14/331,669

(22) Filed: Jul. 15, 2014

(51) Int. Cl. H04N 19/122; H04N 19/70; H04N 19/18

(52) U.S. Cl. CPC H04N 19/122; H04N 19/18; H04N 19/70

(57) ABSTRACT

Systems, apparatus and methods are described including operations for video coding including a stage-interdependent multi-stage butterfly integer transform.

### BACKGROUND

A video encoder compresses video information so that more information can be sent over a given bandwidth. The compressed signal may then be transmitted to a receiver that decodes or decompresses the signal prior to display.

High Efficient Video Coding (HEVC/H.265) is a new video compression standard developed by the Joint Collaborative Team on Video Coding (JCT-VC) formed by ISO/IEC Moving Picture Experts Group (MPEG) and ITU-T Video Coding Experts Group (VCEG). The team will also standardize a Scalable Video Coding (SVC) extension of HEVC standard.

In the current HEVC specification, HEVC/H.265 is more efficient than its predecessors and at the same time computationally intensive. In HEVC, a picture is coded in the unit of Largest Coding Unit (LCU). A LCU can be a 128×128 block, a 64×64 block, a 32×32 block or a 16×16 block. A LCU can be encoded directly or be divided into 4 Coding Unit (CU) for next level encoding. For a CU in one level, it can be encoded directly or be further divided into next level for encoding. The smallest CU is 8×8.

In general, at each level a CU whose size is 2N×2N, may be divided into different size of Prediction Units (PU) for prediction. For intra coding, a 2N×2N CU can be encoded in one 2N×2N PU or in four N×N PUs. For inter coding, a 2N×2N CU can be encoded in one 2N×2N PU, or two 2N×N PUs, or two N×2N PUs, or 0.5N×2N PU+1.5N×2N PU, or 1.5N×2N PU+0.5N×2N PU, or 2N×0.5N PU+2N×1.5N PU, or 2N×1.5N PU+2N×0.5N PU, or four N×N PUs.

In the current HEVC specification, HEVC/H.265 may utilize an algorithm for Integer Transformation of square matrices that are termed as Coding Blocks (CBs). The standard specifies that a CB can be partitioned into multiple square Transform Blocks (TBs) and each TB be transform coded using Integer Transformation. The allowed TB sizes are 4×4, 8×8, 16×16 and 32×32. The encoder may determine the optimal TB size for a CB and hence is required to compute multiple-sized Integer Transformation of all TBs, which is computationally intensive. The 2-D Integer Transform of a TB is typically computed by applying 1-D transform in vertical and horizontal directions and hence the focus is on 1-D Integer Transforms.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is a flow chart illustrating an example prior art integer transform process;

FIG. 3 is an illustrative diagram of an example integer transform process;

FIG. 4 is an illustrative diagram of example integer transform scheme;

FIG. 5 is a flow diagram illustrating an example coding process;

FIG. 6 illustrates an example bitstream;

FIG. 7 is a flow diagram illustrating an example decoding process;

FIG. 8 provides an illustrative diagram of an example video coding system and video coding process in operation;

FIG. 9 is an illustrative diagram of an example video coding system;

FIG. 10 is an illustrative diagram of an example system;

FIG. 11 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for video coding including a stage-interdependent multi-stage butterfly integer transform.

As described above, in the current HEVC specification, HEVC/H.265 may utilize an algorithm for Integer Transformation of square matrices that are termed as Coding Blocks (CBs). The standard specifies that a CB can be partitioned into multiple square Transform Blocks (TBs) and each TB be transform coded using Integer Transformation. The allowed TB sizes are 4×4, 8×8, 16×16 and 32×32. The encoder may determine the optimal TB size for a CB and hence is required to compute multiple-sized Integer Transformation of all TBs, which is computationally intensive. The 2-D Integer Transform of a TB is typically computed by applying 1-D transform in vertical and horizontal directions and hence the focus is on 1-D Integer Transforms.

The widely used partial butterfly algorithm might be a good method for implementing Integer Transformation of fixed sized vectors. However, for multiple sized sub-vectors, partial butterfly algorithm transforms each of the sub-vectors separately and hence is not optimal.

As will be described in greater detail below, in some implementations of the present disclosure, an integer transform process is described that may perform a multi-stage butterfly algorithm derived to efficiently use the outputs from each stage to compute the transformation of different sizes. For example, in some implementations of the present disclosure, a multi-stage butterfly algorithm may be derived, wherein the outputs of each stage are used to compute the transformation of different sized sub-vectors, before being fed into the next stage as inputs. The number of butterfly stages for an N-length input vector is log 2N−1. Existing techniques such as partial butterfly algorithm also computes the transformation in log 2N−1 stages; however, in existing technique the outputs of each stage is only used as input to the next stage. Thus, the efficient use of intermediate outputs in some implementations of the present disclosure may helps in reducing the overall computational complexity of the transformation.

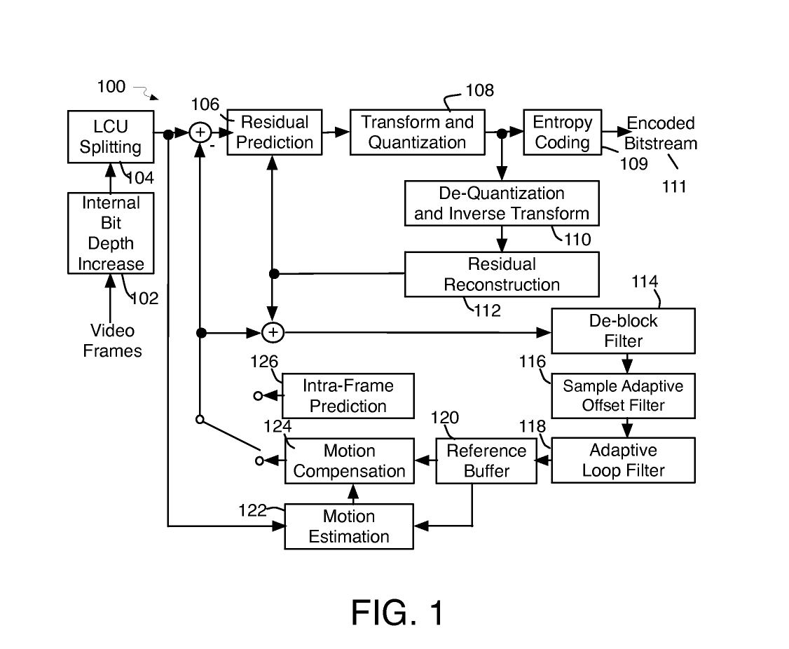

FIG. 1 is an illustrative diagram of an example video coding system 100, arranged in accordance with at least some implementations of the present disclosure. In various implementations, video coding system 100 may be configured to undertake video coding and/or implement video codecs according to one or more advanced video codec standards, such as, for example, the High Efficiency Video Coding (HEVC) H.265 video compression standard being developed by the Joint Collaborative Team on Video Coding (JCT-VC) formed by ISO/IEC Moving Picture Experts Group (MPEG) and ITU-T Video Coding Experts Group (VCEG).

Further, in various embodiments, video coding system 100 may be implemented as part of an image processor, video processor, and/or media processor and may undertake inter prediction, intra prediction, predictive coding, and/or residual prediction including cross-channel residual prediction in accordance with the present disclosure.

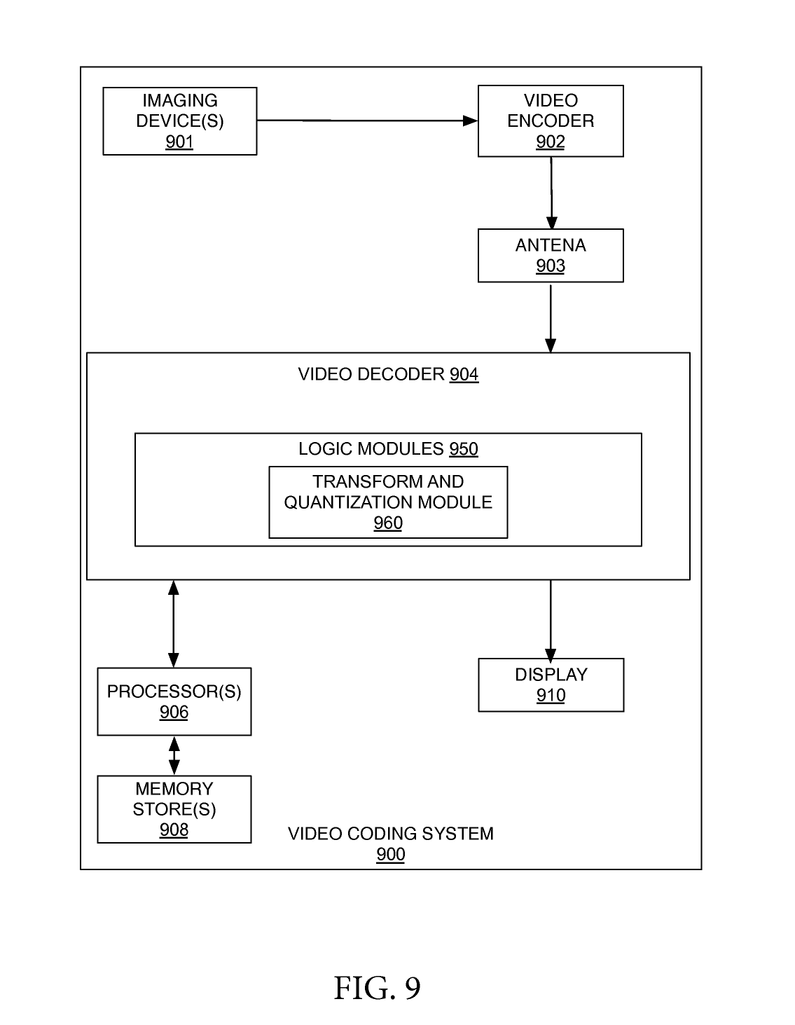

As used herein, the term “coder” may refer to an encoder and/or a decoder. Similarly, as used herein, the term “coding” may refer to encoding via an encoder and/or decoding via a decoder. For example video encoders and video decoders as described herein (e.g., see FIG. 9) may both be examples of coders capable of coding.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic, etc. that have not been shown in FIG. 1 for the sake of clarity.

In some examples, during the operation of video coding system 100, current video information may be provided to an internal bit depth increase module 102 in the form of a frame of video data. The current video frame may be split into Largest Coding Units (LCUs) at module 104 and then passed to a residual prediction module 106. The output of residual prediction module 106 may be subjected to known video transform and quantization processes by a transform and quantization module 108. The output of transform and quantization module 108 may be provided to an entropy coding module 109 and to a de-quantization and inverse transform module 110. Entropy coding module 109 may output an entropy encoded bitstream 111 for communication to a corresponding decoder.

Within the internal decoding loop of video coding system 100, de-quantization and inverse transform module 110 may implement the inverse of the operations undertaken by transform and quantization module 108 to provide the output of residual prediction module 106 to a residual reconstruction module 112. Those skilled in the art may recognize that transform and quantization modules and de-quantization and inverse transform modules as described herein may employ scaling techniques. The output of residual reconstruction module 112 may be fed back to residual prediction module 106 and may also be provided to a loop including a de-blocking filter 114, a sample adaptive offset filter 116, an adaptive loop filter 118, a buffer 120, a motion estimation module 122, a motion compensation module 124 and an intra-frame prediction module 126. As shown in FIG. 1, the output of either motion compensation module 124 or intra-frame prediction module 126 is both combined with the output of residual prediction module 106 as input to de-blocking filter 114, and is differenced with the output of LCU splitting module 104 to act as input to residual prediction module 106.

As will be explained in greater detail below, transform and quantization module 108 may utilize a multi-stage butterfly algorithm. For example, an input vector received by the transform and quantization module 108. The logic of such a multi-stage butterfly algorithm may combines the coefficients of this input vector via a series of addition/multiplication operations to output intermediate E and O coefficients for each successive stage of the multi-stage butterfly algorithm. For example, for a first stage, the logic of multi-stage butterfly algorithm may combines the coefficients of the input vector via a series of addition/multiplication operations to output intermediate E and O coefficients associated with the first stage. Similarly, the logic of multi-stage butterfly algorithm may combines these output intermediate E and O coefficients associated with the first stage via a series of addition/multiplication operations to further output further intermediate E and O coefficients associated with a second stage of the multi-stage butterfly algorithm, and so on. These intermediate E and O coefficients may be calculated at each stage (e.g., stage one, stage two, stage three 403, and so on) of the multi-stage butterfly algorithm and output to be passed to a subsequent stage of the multi-stage butterfly algorithm.

Further, these E and O coefficients, as utilized in the multi-stage butterfly algorithm of transform and quantization module 108, may be used in the original stage they were calculated in to compute output transformed vectors at each stage via a transformation of the i^{th} sub-vector at that same stage. These output transformed vectors may also be passed to a subsequent stage of the multi-stage butterfly algorithm for use in the determination of output transformed vectors at that subsequent stage.

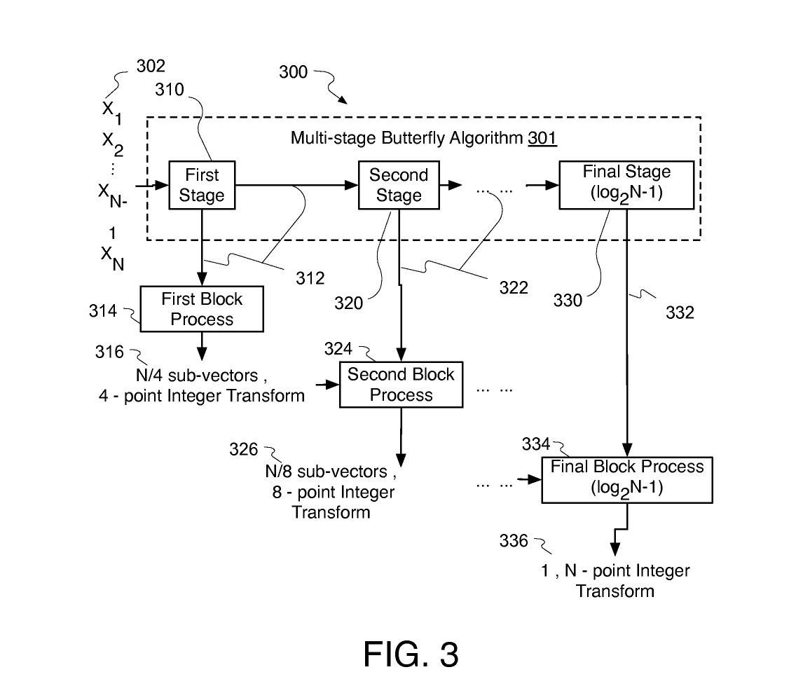

As will be discussed in greater detail below, video coding system 100 may be used to perform some or all of the various functions discussed below in connection with FIGS. 3-8.

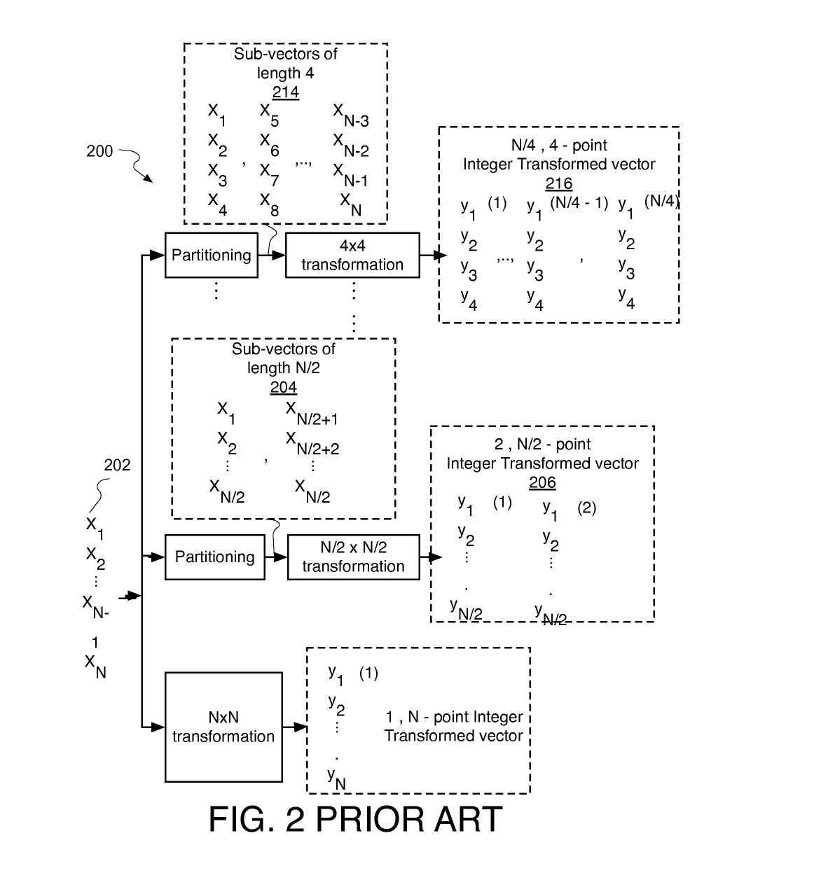

FIG. 2 is a flow chart illustrating an example prior art integer transform process 200. As described above, the current HEVC specification, HEVC/H.265 may utilize an algorithm for Integer Transformation of square matrices that are termed as Coding Blocks (CBs). The standard specifies that a CB can be partitioned into multiple square Transform Blocks (TBs) and each TB be transform coded using Integer Transformation. The allowed TB sizes are 4×4, 8×8, 16×16 and 32×32. The encoder may determine the optimal TB size for a CB and hence is required to compute multiple-sized Integer Transformation of all TBs, which is computationally intensive. The 2-D Integer Transform of a TB is typically computed by applying 1-D transform in vertical and horizontal directions and hence the focus is on 1-D Integer Transforms.

As illustrated, FIG. 2 shows an example prior art multiple-sized Integer Transformation process 200 of an N-length vector. The input vector 202 may be partitioned into equal sized sub-vectors 204 and each sub-vector may be transformed into N/2 point integer transformed vectors 206. For example, a 4-point transformation may be obtained by first partitioning input vector 202 into N/4 sub-vectors 214, each of length 4, followed by 4-point transformation of each of the sub-vectors into N/4 point integer transformed vectors 216. Each sub-vector in this scenario belongs to a 4×4 TB.

The widely used partial butterfly algorithm might be a good method for implementing Integer Transformation of fixed sized vectors. However, for multiple sized sub-vectors, partial butterfly algorithm transforms each of the sub-vectors in FIG. 2 independently and hence is not optimal.

FIG. 3 is an illustrative diagram of an example integer transform process 300, arranged in accordance with at least some implementations of the present disclosure. As illustrated, integer transform process 300 may operate on an input vector 302 of length N. A first stage 310 may compute outputs 312 from Stage 1 based at least in part on one stage of a multistage butterfly-type operation 301 on the input vector 302. Also at Stage 1, the 4×4 transformation of the sub-vectors at first block process 314 may be computed to generate transformed vectors 316 using only the outputs 312 from Stage 1. In the illustrated example, the total number of transformed vectors 316 in Stage 1 is N/4.

Similarly, a second stage 320 may compute outputs 322 from Stage 2 based at least in part on another stage of the multistage butterfly-type operation 301 on the outputs 312 from Stage 1. Also at Stage 2, the 8×8 transformation of the sub-vectors at second block process 324 may be computed to generate a first portion of transformed vectors 326 using the outputs 322 from Stage 2. Additionally, transformed vectors 316 from Stage 1 may be used in this subsequent stage to generate a second portion of transformed vectors 326. In the illustrated example, the total number of transformed vectors 326 in Stage 2 is N/8.

Accordingly, in the subsequent stages, the higher-sized transformations may be computed using the outputs (e.g., outputs 312, 322, etc.) from the corresponding stages (e.g., first stage 310, second stage 320, etc.) as well as the transformed vectors (e.g., transformed vectors 316, 326, etc.) from the immediately previous stage. This process may be repeated until the final stage 330 (e.g., Stage log₂ N−1) where an N×N transformation may be computed to generate a single transformed vector 336. The number of transformed vectors at each stage decreases as the size of transformation increases with stage number. As stipulated by the HEVC standard the value of N can be 32, 16 or 8, for example.

In some implementations of the present disclosure, integer transform process 300 may simultaneously compute Integer Transformations of all sub-vector sizes defined by HEVC standard, thus improving the overall performance. For example, integer transform process 300 may exploit two basic properties of the different sized (4×4, 8×8, 16×16 and 32×32) Integer Transform matrices specified by the HEVC/H.265 standard. Firstly, the lower sized Integer Transform matrices (4×4, 8×8 and 16×16) may be subsampled versions of the upper sized 32×32 Transform matrix. Hence, the transformed vectors of lower sizes may be used in computation of higher sized transformations, thus removing redundant calculations. Secondly, the rows of the Integer Transform matrix may possess a highly symmetric property, which may be used to further reduce the computational complexity. The latter property is used in techniques such as the partial butterfly algorithm. However, integer transform process 300 may combine these two separate and distinct properties to derive an algorithm that reduces the overall computational complexity in obtaining transformation of multiple-sized sub-vectors of the given input vector.

In operation, integer transform process 300 may derive a multi-stage butterfly algorithm 301, wherein the outputs of each stage may be used to compute the transformation of different sized sub-vectors, before the outputs of each stage and the calculated transformed vectors of each stage being fed into the next stage as inputs. As illustrated, the number of butterfly stages for an N-length input vector is log₂ N−1. Existing techniques such as the partial butterfly algorithm may also compute the transformation in log₂ N−1 stages; however, the outputs of intermediate stages themselves cannot be used for computing any transformation; further, the lower sized transformed vectors are not used in computation of higher sized transformed vectors. Thus, the efficient use of intermediate outputs in integer transform process 300 may helps in reducing the overall computational complexity of the transformation.

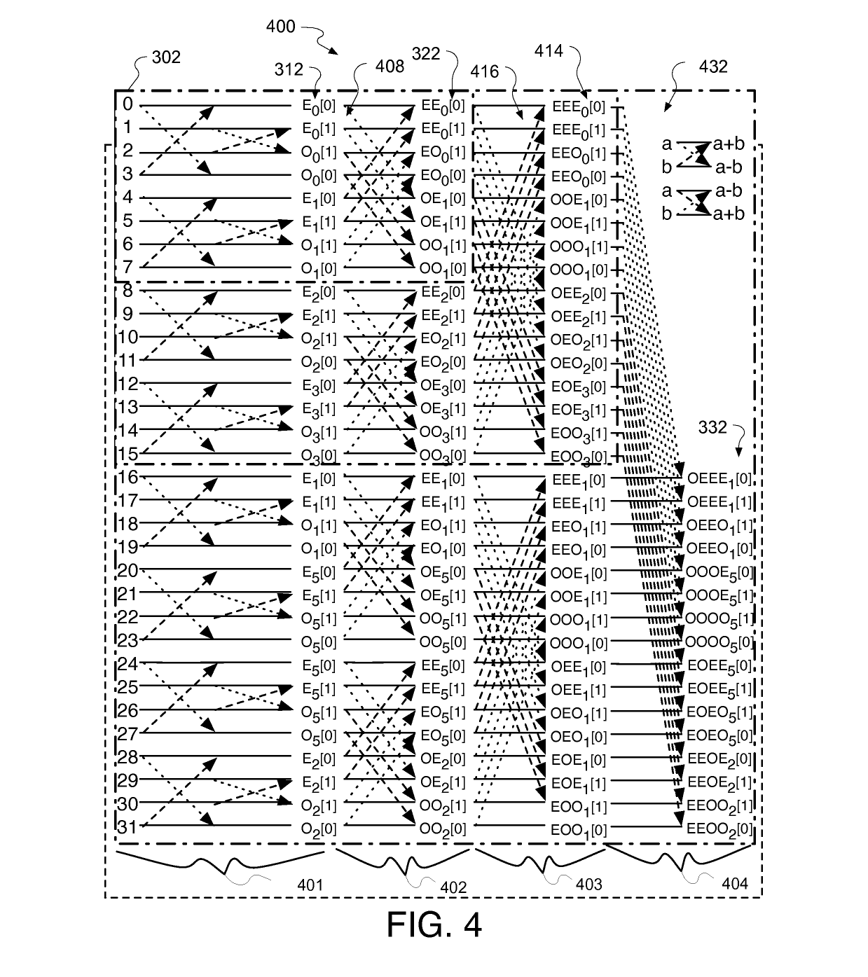

FIG. 4 is an illustrative diagram of example integer transform scheme 400, arranged in accordance with at least some implementations of the present disclosure. As illustrated, integer transform scheme 400 may perform an example of multi-stage butterfly algorithm 301 derived to efficiently use the outputs from each stage (e.g., stage one 401, stage two 402, stage three 403, stage four 404, and so on) to compute the transformation of different sizes.

As illustrated in FIG. 4, the diagram of integer transform scheme 400 shows the logic of multi-stage butterfly algorithm 301 for N=8, 16 and 32. The logic of multi-stage butterfly algorithm 301 combines the coefficients of the input vector 302 via a series of addition/multiplication operations to output intermediate E and O coefficients for each successive stage (e.g., stage one 401, stage two 402, stage three 403, stage four 404, and so on). For example, for first stage 401, the logic of multi-stage butterfly algorithm 301 may combines the coefficients of the input vector 302 via a series of addition/multiplication operations to output intermediate E and O coefficients 312 associated with the first stage 401. Similarly, the logic of multi-stage butterfly algorithm 301 may combines the output intermediate E and O coefficients 312 associated with the first stage 401via a series of addition/multiplication operations to output intermediate E and O coefficients 322 associated with the second stage 402, and so on.

The intermediate E and O coefficients (e.g., as may be output at 312, 322, and 332) are represented here by the same index. For example, E and O coefficients 312 in the first stage 401 may be represented in such an index as Eᵢ[0], Eᵢ[1], Oᵢ[0], Oᵢ[1] where i={0,1,2,3,4,5,6,7}. These E and O coefficients 312/322/332 may be calculated at each stage (e.g., stage one 401, stage two 402, stage three 403, stage four 404, and so on) and output to pass to a subsequent stage. Further, these E and O coefficients 312/322/332 may be used in the stage they were calculated in to compute the transformation of the i^{th} sub-vector at that same stage. For example, such a computation of the transformation of the i^{th} sub-vector may occur in the respective first block process 314, second block process 324, or final block process 334 to calculate the respective transform vectors 316, 326, or 336, as illustrated in FIG. 3.

As illustrated in FIG. 4, the output E and O coefficients 322 within the dashed block 408 may be operated on by an 8×8 transform matrix(e.g., see table 3, discussed below) to partially obtain 8-point transformed vector 326 of input vector 302 of length 8. Similarly, the output E and O coefficients 414 within the dashed block 416 may be operated on by a 16×16 transform matrix, the output E and O coefficients 332 within the dashed block 432 may be operated on by a 32×32 transform matrix, to partially obtain 16-point and 32-point transformed vectors, respectively.

In operation, the number of first stage transformed sub-vectors output from the first stage 401 may be higher than the number of intermediate stage transformed sub-vectors output from one of the intermediate stages 402 or 403, while the size of the first stage integer transform matrix (e.g., see the 4×4 transform matrix of Table 3 below) may be smaller than the size of the intermediate stage integer transform matrix (e.g., see the 8×8 or 16×16 transform matrix of Table 3 below).

Table 1, illustrated below, shows the performance comparison between two different methods, at traditional partial butterfly method (e.g., as illustrated in FIG. 2) and a “new algorithm” (e.g., as illustrated in FIG. 4). The memory required for transformation is the same in both techniques as in-place operations are used. Similar to the existing partial butterfly algorithm, the a multi-stage butterfly algorithm as described herein may be suitable for implementation in SIMD environment such as GPUs, as the multi-stage butterfly algorithm may performs similar addition/multiplication operations on all sub-vectors in each stage. Further, a multi-stage butterfly algorithm as described herein may also be implemented as a fixed function hardware block.

The multi-stage butterfly algorithm as described herein leverages the fact that transformed vectors of different sizes in a butterfly method may be closely related to one another since Integer Transform matrices of lower sizes may be sub-sampled versions of higher sized matrices. The traditional partial butterfly algorithm does not exploit this property and instead computes the transformation independently for all the sub-vectors.

In some implementations of the multi-stage butterfly algorithm of the present disclosure, this sub-sampled property may be utilized to further reduce the number of operations required to compute the transformation of all sizes.

The number of multiplication and addition operations required for transformation of various sized sub-vectors using both the algorithms (e.g., the proposed multi-stage butterfly algorithm as illustrated in FIG. 4 as compared to the traditional partial butterfly algorithm as illustrated in FIG. 2) is compared and the tested multi-stage butterfly algorithm achieves up to a 24% improvement in performance depending on CB size.

TABLE 1

| | | | | | Multi-Stage | | | Difference | |
|---|---|---|---|---|---|---|---|---|---|
| | | Partial butterfly | | | Butterfly | | | in no. of | % |
| CBsize | TB sizes | Mul | Add | Total | Mul | Add | Total | operations | gain |
| 32 × 32 | 32 × 32, 16 × 16, 8 × 8 | 698 | 684 | 1382 | 560 | 592 | 1152 | 230 | 16.6 |
| 16 × 16 | 16 × 16, 8 × 8, 4 × 4 | 202 | 188 | 390 | 144 | 152 | 296 | 94 | 24.1 |
| 8 × 8 | 8 × 8, 4 × 4 | 50 | 44 | 94 | 36 | 36 | 72 | 22 | 23.4 |

In the experimental results discussed above in Table 1, the multi-stage butterfly algorithm was implemented in C program and the experimental results were validated by comparing with results from partial butterfly algorithm.

Table 2, as illustrated below, provides one complete set of equations for obtaining the intermediate results at each stage of the multi-stage butterfly algorithm of FIG. 4 for an input vector of length N=32. For smaller lengths N=8 and N=16, only a subset of these equations may be used. The equations for obtaining different sized transformations of sub-vectors using the intermediate results (Stage outputs) and lower sized transformed vectors are also provided in Table 2. The 4-point transformed vector of the i^{th} sub-vector of length 4 is denoted by D4ᵢ. Similarly, the 8×8, 16×16 and 32×32 transformed vectors are denoted by D8ᵢ, D16ᵢ and D32ᵢ, respectively.

Referring to Table 2, it can be noted that the higher sized transformed vectors may be derived from lower sized transformed vectors. For example, some of the elements in transformed vectors D16ᵢ are derived from D8₂ᵢ (e.g., D16ᵢ[k] for k=0, 4, 8, and 12 as well as k=2, 6, 10, and 14) that are the transformed vectors output from the previous stage, while others of the elements in transformed vectors D16ᵢ are derived from the E and O coefficients (e.g., D16ᵢ[k] for k=1, 3, 5, 7, 9, 11, 13, and 15).

The transform matrices denoted in Table 2 by DCT4, DCT8, DCT16 and DCT 32 for 4×4, 8×8, 16×16 and 32×32 Transformations, respectively, may be modified versions of the Integer Transform matrices provided by the HEVC standard. These new transformation matrices may be linear transformations of the Integer Transform matrices and are a consequence of the nature of butterfly outputs in FIG. 4. Further information regarding these new transformation matrices may be found below with regard to Table 3.

TABLE 2

| Stage No | Stage Outputs | Transformed vectors |
|---|---|---|
| 1 | i = 0, 1, 2, 3, 4, 5, 6, 7 | (4 × 4 Transformation) |
| | Eᵢ[0] = src[4 * i] + src[4 * i + 3] | i = 0, 1, 2, 3, 4, 5, 6, 7 |
| | Eᵢ[1] = src[4 * i + 1] + src[4 * i + 2] | D4ᵢ[0] = (DCT4[0][0] * Eᵢ[0] + DCT4 [0][1] * Eᵢ[1]); |
| | Oᵢ[1] = src[4 * i + 1] − src[4 * i + 2] | D4ᵢ[1] = (DCT4[1][0] * Oᵢ[0] + DCT4 [1][1] * Oᵢ[1]); |
| | Oᵢ[0] = src[4 * i] − src[4 * i + 3] | D4ᵢ[2] = (DCT4 [2][0] * Eᵢ[0] + DCT4 [2][1] * Eᵢ[1]); |
| | | D4ᵢ[3] = (DCT4 [3][0] * Oᵢ[0] + DCT4 [3][1] * Oᵢ[1]); |
| 2 | i = 0, 1, 2, 3 | (8 × 8 Transformation) |
| | EEᵢ[0] = E₂ᵢ[0] + E₂ᵢ₊₁[0] | i = 0, 1, 2, 3 |
| | EEᵢ[1] = E₂ᵢ[1] + E₂ᵢ₊₁[1] | D8ᵢ[0] = D4₂ᵢ[k/2] + D4₂ᵢ₊₃[k/2]; k = 0, 4 |
| | EOᵢ[1] = E₂ᵢ[1] − O₂ᵢ₊₁[1] | D8ᵢ[0] = D4₂ᵢ[k/2] − D4₂ᵢ₊₁[k/2]; k = 2, 6 |
| | EOᵢ[0] = O₂ᵢ[0] − O₂ᵢ₋₁[0] | D8ᵢ[k] = (DCT8[k][0] * OEᵢ[0] + DCT8[k][1] * OEᵢ[1] + |
| | OEᵢ[0] = E₂ᵢ[0] − E₂ᵢ₊₁[0] | DCT8[k][2] * OOᵢ[1] + DCT8[k][3] * OOᵢ[0]) >> 1; |
| | OEᵢ[1] = E₂ᵢ[1] − E₂ᵢ₊₁[1] | k = 1, 3, 5, 7 |
| | OOᵢ[1] = O₂ᵢ[1] + O₂ᵢ₊₁[1] | |
| | OOᵢ[0] = O₂ᵢ[0] + O₂ᵢ₊₁[0] | |
| 3 | i = 0, 1 | (16 × 16 Transformation) |
| | EEEᵢ[0] = EE₂ᵢ[0] + EE₂ᵢ₊₁[0] | i = 0, 1 |
| | EEEᵢ[1] = EE₂ᵢ[1] + EE₂ᵢ₊₁[1] | D16ᵢ[k] = D8₂ᵢ[k/2] + D8₂ᵢ₊₁[k/2]; k = 0, 4, 8, 12 |
| | EEOᵢ[1] = EO₂ᵢ[1] + EO₂ᵢ₊₁[1] | D16ᵢ[k] = D8₂ᵢ[k/2] − D8₂ᵢ₊₁[k/2]; k = 2, 6, 10, 14 |
| | EEOᵢ[0] = EO₂ᵢ[0] + EO₂ᵢ₊₁[0] | D16ᵢ[k] = (DCT16[k][0] OEEᵢ[0] + DCT16[k][1] OEEᵢ[1] + |
| | OOEᵢ[0] = OE₂ᵢ[0] − OE₂ᵢ₊₁[0] | DCT16[k][2] OEOᵢ[1] + DCT16[k][3] OEOᵢ[0] + |
| | OOEᵢ[1] = OE₂ᵢ[1] − OE₂ᵢ₊₁[1] | DCT16[k][4] EOEᵢ[0] + DCT16[k][5] EOEᵢ[1] + |
| | OOOᵢ[1] = OO₂ᵢ[1] − OO₂ᵢ₊₁[1] | DCT16[k][6] EOOᵢ[1] + DCT16[k][7] EOOᵢ[0]) >> 2; |
| | OOOᵢ[0] = OO₂ᵢ[0] − OO₂ᵢ₊₁[0] | k = 1, 3, 5, 7, 9, 11, 13, 15 |
| | OEEᵢ[0] = EE₂ᵢ[0] − EE₂ᵢ₊₁[0] | |
| | OEEᵢ[1] = EE₂ᵢ[1] − EE₂ᵢ₊₁[1] | |
| | OEOᵢ[1] = EO₂ᵢ[1] − EO₂ᵢ₊₁[1] | |
| | OEOᵢ[0] = EO₂ᵢ[0] − EO₂ᵢ₊₁[0] | |
| | EOEᵢ[0] = OE₂ᵢ[0] + OE₂ᵢ₊₁[0] | |
| | EOEᵢ[1] = OE₂ᵢ[1] + OE₂ᵢ₊₁[1] | |
| | EOOᵢ[1] = OO₂ᵢ[1] + OO₂ᵢ₊₁[1] | |
| | EOOᵢ[0] = OO₂ᵢ[0] + OO₂ᵢ₊₁[0] | |
| 4 | i = 0 | (32 × 32 Transformation) |
| | OEEEᵢ[0] = EEEᵢ[0] − EEEᵢ₊₁[0] | i = 0 |
| | OEEEᵢ[1] = EEEᵢ[1] − EEEᵢ₊₁[1] | D32[k] = D16₀[k/2] + (−1)^{k/2}D16ᵢ[k/2]; |
| | OEEOᵢ[1] = EEOᵢ[1] − EEOᵢ₊₁[1] | k = 0, 2, 4, 6, 8, 10, 12, 14, 16, 18, 20, 22, 24, 26, 28, 30 |
| | OEEOᵢ[0] = EEOᵢ[0] − EEOᵢ₊₁[0] | D32[k] = (DCT32 [k][0] * OEEEᵢ[0] + DCT32 [k][1] * OEEEᵢ[1] + |
| | OOOEᵢ[0] = OOEᵢ[0] − OOEᵢ₊₁[0] | DCT32[k][2] * OEEOᵢ[1] + DCT32[k][3] * OEEOᵢ[0] + |
| | OOOEᵢ[1] = OOEᵢ[1] − OOEᵢ₊₁[1] | DCT32[k][4] * OOOEᵢ[0] + DCT32[k][5] * OOOEᵢ[1] + |
| | OOOOᵢ[1] = OOOᵢ[1] − OOOᵢ₊₁[1] | DCT32[k][6] * OOOOᵢ[1] + DCT32[k][7] * OOOOᵢ[0] + |
| | OOOOᵢ[0] = OOOᵢ[0] − OOOᵢ₊₁[0] | DCT32[k][8] * EOEEᵢ[1] + DCT32[k][9] * EOEEᵢ[1] + |
| | EOEEᵢ[0] = OEEᵢ[0] + OEEᵢ₊₁[0] | DCT32[k][10] * EOEOᵢ[1] + DCT32[k][11] * EOEOᵢ[0] + |
| | EOEEᵢ[1] = OEEᵢ[1] + OEEᵢ₊₁[1] | DCT32[k][12] * EEOEᵢ[0] + DCT32[k][13] * EEOEᵢ[1] + |
| | EOEOᵢ[1] = OEOᵢ[1] + OEOᵢ₊₁[1] | DCT32 [k][14] EEOOᵢ[1] + DCT32 [k][15] |
| | EOEOᵢ[0] = OEOᵢ[0] + OEOᵢ₊₁[0] | EEOOᵢ[0]) >> 3; |
| | EEOEᵢ[0] = EOEᵢ[0] + EOEᵢ₊₁[0] | k = 1, 3, 5, 7, 9, 11, 13, 15, 17, 19, 21, 23, 25, 27, 29, 31 |
| | EEOEᵢ[1] = EOEᵢ[1] + EOEᵢ₊₁[1] | |
| | EEOOᵢ[1] = EOOᵢ[1] + EOOᵢ₊₁[1] | |
| | EEOOᵢ[0] = EOOᵢ[0] + EOOᵢ₊₁[0] | |

In the examples transform matrixes illustrated below, several transformation matrices are provided in Table 3. It should be noted that similar to the Integer Transform matrices, the modified transform matrices of lower sizes are sub-sampled versions of higher sizes. For example, in some implementations, the lower sized integer transform matrix and one or more intermediate sized integer transform matrixes may be subsampled versions of the upper sized integer transform matrix. Similarly, the lower sized integer transform matrix may be a subsampled version of the upper sized integer transform matrix as well as a subsampled version of the one or more intermediate sized integer transform matrixes.

Further, in the examples illustrated below, the lower sized integer transform matrix, the one or more intermediate sized integer transform matrix, and the upper sized transform matrix may all be at least partially symmetric. For example, the two 8×4 sub-matrices of DCT8 matrix may be identical and hence only the first 8×4 sub-matrix is shown in Table 3. Similarly, DCT16 and DCT32 matrices in Table 3 may contain identical 16×8 and 32×16 sub-matrices, respectively.

TABLE 3

4×4 Transform Matrix Size

short DCT4[4][4] ={

{ 64, 64, 64, 64},
{ 83, 36,−36,−83},
{ 64, −64, −64, 64},
{ 36, −83, 83, −36}

};
8×8 Transform Matrix Size

short DCT8[8][4] ={

{ 64, 64, 64 , 64},
{ 107, 125, 25 , 71},
{ 83, 36, −36 ,−83},
{ 25, −107, 71 ,125},
{ 64, −64, −64 , 64},
{ 125, −71, −107,−25},
{ 36, −83, 83 ,−36},
{ −71, 25, −125,107}

};
16×16 Transform Matrix Size

short DCT16[16][8] ={
{ 64, 64, 64, 64, 64, 64, 64, 64, },
{ 226, 235, −11, −28, 94, 99, 25, 68, },
{ 107, 125, 25, 71, 107, 125, 25, 71, },
{ −61, −94, 68, 185, 149, 226, 28, 75, },
{ 83, 36, −36, −83, −83, −36, 36, 83, },
{ 11, 86, 112, 235, −25, −208, 46, 99, },
{ 25, −107, 71, 125, 25, −107, 71, 125, },
{ 112, −185, −61, −86, 46, −75, 149, 208, },
{ 64, −64, −64, 64, 64, −64, −64, 64, },
{ 208, −149, 75, 46, 86, −61, −185, −112, },
{ 125, −71, −107, −25, 125, −71, −107, −25, },
{ −99, 46, −208, 25, 235, −112, −86, 11, },
{ 36, −83, 83, −36, −36, 83, −83, 36, },
{ 75, −28, −226, 149, −185, 68, −94, 61, },
{ −71, 25, −125, 107, −71, 25, −125, 107, },
{ −68, 25, 99, −94, −28, 11, −235, 226, }
};

32×32 Transform Matrix Size

short DCT32[32][16] = {

{ 64, 64, 64, 64, 64, 64, 64, 64, 64, 64, 64, 64, 64, 64, 64, 64, },
{ 458, 464, −4, −14, −38, −38, −10, −30, 190, 194, −2, −6,
90, 92, 24, 70, },
{ 226, 235, −11, −28, 94, 99, 25, 68, 226, 235, −11, −28, 94,
99, 25, 68, },
{−148, −160, 16, 48, 238, 260, 60, 170, 356, 388, −40, −112,
98, 108, 24, 70, },
{ 107, 125, 25, 71, 107, 125, 25, 71, 107, 125, 25, 71, 107,
125, 25, 71, },
{ 82, 106, −38, −110, 292, 382, 62, 176, −196, −254, 94, 264,
122, 158, 26, 74, },
{ −61, −94, 68, 185, 149, 226, 28, 75, −61, −94, 68, 185, 149,
226, 28, 75, },
{ −48, −88, 156, 396, −100, −182, −14, −32, −20, −36, 64,
164, 240, 438, 30, 80, },
{ 83, 36, −36, −83, −83, −36, 36, 83, 83, 36, −36, −83,
−83, −36, 36, 83, },
{ 22, 84, 200, 450, 46, 174, −18, −38, 10, 34, 82, 186, −110,
−420, 40, 90, },
{ 11, 86, 112, 235, −25, −208, 46, 99, 11, 86, 112, 235, −25,
−208, 46, 99, },
{ 6, −92, −84, −162, 20, −336, 136, 264, −14, 224, 204, 394,
8, −140, 56, 108, },
{ 25, −107, 71, 125, 25, −107, 71, 125, 25, −107, 71, 125,
25, −107, 71, 125, },
{ −54, 132, 64, 102, 88, −212, 232, 372, 132, −316, −156, −248,
38, −88, 96, 154, },
{ 112, −185, −61, −86, 46, −75, 149, 208, 112, −185, −61, −86,
46, −75, 149, 208, },
{ 274, −346, −62, −74, −22, 28, −128, −154, 114, −142, −26,
−30, 54, −68, 312, 374, },
{ 64, −64, −64, 64, 64, −64, −64, 64, 64, −64, −64, 64, 64,
−64, −64, 64, },
{ 374, −312, 68, 54, −30, 26, 142, 114, 154, −128, 28, 22, 74,
−62, −346, −274, },
{ 208, −149, 75, 46, 86, −61, −185, −112, 208, −149, 75, 46, 86,
−61, −185, −112, },
{−154, 96, −88, −38, 248, −156, −316, −132, 372, −232, 212, 88,
102, −64, −132, −54, },
{ 125, −71, −107, −25, 125, −71, −107, −25, 125, −71, −107, −25,
125, −71, −107, −25, },
{ 108, −56, 140, 8, 394, −204, −224, −14, −264, 136, −336, −20,
162, −84, −92, −6, },
{ −99, 46, −208, 25, 235, −112, −86, 11, −99, 46, −208, 25,
235, −112, −86, 11, },
{ −90, 40, −420, 110, −186, 82, 34, −10, −38, 18, −174, 46,
450, −200, −84, 22, },
{ 36, −83, 83, −36, −36, 83, −83, 36, 36, −83, 83, −36, −36,
83, −83, 36, },
{ 80, −30, −438, 240, 164, −64, 36, −20, 32, −14, −182, 100,
−396, 156, −88, 48, },
{ 75, −28, −226, 149, −185, 68, −94, 61, 75, −28, −226, 149,
−185, 68, −94, 61, },
{ −74, 26, 158, −122, −264, 94, −254, 196, 176, −62, −382, 292,
−110, 38, −106, 82, },
{ −71, 25, −125, 107, −71, 25, −125, 107, −71, 25, −125, 107,
−71, 25, −125, 107, },
{ 70, −24, −108, 98, −112, 40, −388, 356, −170, 60, 260, −238,
−48, 16, −160, 148, },
{ −68, 25, 99, −94, −28, 11, −235, 226, −68, 25, 99, −94,
−28, 11, −235, 226, },
{ −70, 24, 92, −90, 6, −2, 194, −190, −30, 10, 38, −38,
−14, 4, −464, 458, }

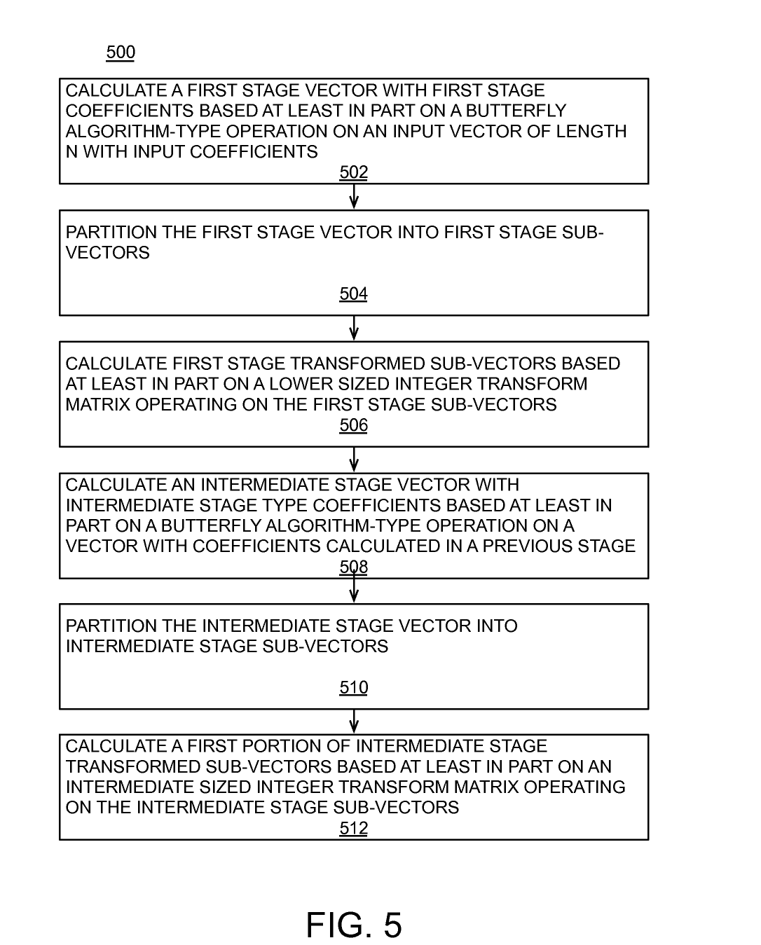

FIG. 5 is a flow diagram illustrating an example integer transform coding process 500, arranged in accordance with at least some implementations of the present disclosure. Process 500 may include one or more operations, functions or actions as illustrated by one or more of operations 502, etc.

Process 500 may begin at operation 502, “CALCULATE A FIRST STAGE VECTOR WITH FIRST STAGE COEFFICIENTS BASED AT LEAST IN PART ON A BUTTERFLY ALGORITHM-TYPE OPERATION ON AN INPUT VECTOR OF LENGTH N WITH INPUT COEFFICIENTS”, where a first stage vector with first stage coefficients may be calculated. For example, a first stage vector with first stage coefficients may be calculated based at least in part on a butterfly algorithm-type operation on an input vector of length N with input coefficients.

Process 500 may continue at operation 504, “PARTITION THE FIRST STAGE VECTOR INTO FIRST STAGE SUB-VECTORS”, where, the first stage vector may be partitioned. For example, the first stage vector may be partitioned into first stage sub-vectors.

Process 500 may continue at operation 506, “CALCULATE FIRST STAGE TRANSFORMED SUB-VECTORS BASED AT LEAST IN PART ON A LOWER SIZED INTEGER TRANSFORM MATRIX OPERATING ON THE FIRST STAGE SUB-VECTORS”, where first stage transformed sub-vectors may be calculated. For example, first stage transformed sub-vectors may be calculated based at least in part on a lower sized integer transform matrix operating on the first stage sub-vectors.

In some implementations, some or all of operations 502-506 may be considered as occurring in a first stage, which may be followed by one or more similar stages, as will be described below. For example, such a first stage of operations 502-506 may be followed by one or more intermediate stages, and/or a final stage following the one or more intermediate stages. The one or more intermediate stages may be illustrated below as including some or all of operations 508-512.

Process 500 may continue at operation 508, “CALCULATE AN INTERMEDIATE STAGE VECTOR WITH INTERMEDIATE STAGE TYPE COEFFICIENTS BASED AT LEAST IN PART ON A BUTTERFLY ALGORITHM-TYPE OPERATION ON A VECTOR WITH COEFFICIENTS CALCULATED IN A PREVIOUS STAGE”, where an intermediate stage vector with intermediate stage type coefficients may be calculated. For example, an intermediate stage vector with intermediate stage type coefficients may be calculated based at least in part on a butterfly algorithm-type operation on a vector with coefficients calculated in a previous stage.

Process 500 may continue at operation 510, “PARTITION THE INTERMEDIATE STAGE VECTOR INTO INTERMEDIATE STAGE SUB-VECTORS”, where the intermediate stage vector may be partitioned. For example, the intermediate stage vector may be partitioned into intermediate stage sub-vectors.

Process 500 may continue at operation 512, “CALCULATE A FIRST PORTION OF INTERMEDIATE STAGE TRANSFORMED SUB-VECTORS BASED AT LEAST IN PART ON AN INTERMEDIATE SIZED INTEGER TRANSFORM MATRIX OPERATING ON THE INTERMEDIATE STAGE SUB-VECTORS”, where, a first portion of intermediate stage transformed sub-vectors may be calculated. For example, a first portion of intermediate stage transformed sub-vectors may be calculated based at least in part on an intermediate sized integer transform matrix operating on the intermediate stage sub-vectors.

In operation, integer transform process 500 may utilize a multi-stage butterfly algorithm, wherein the outputs of each stage may be used to compute the transformation of different sized sub-vectors, before the outputs of each stage and the calculated transformed vectors of each stage are fed into a subsequent stage as inputs. For example, the number of butterfly stages for an N-length input vector is log₂ N−1. Existing techniques such as the partial butterfly algorithm may also compute the transformation in log₂ N−1 stages. However, in existing techniques the outputs of intermediate stages themselves are never used in computation of transformed vectors. Similarly, in existing techniques the calculated transformed vectors of each stage are never used as an input to the next stage. Thus, the efficient use of intermediate outputs in integer transform process 500 may helps in reducing the overall computational complexity of the transformation.

Process 500 may provide for video coding, such as video encoding, decoding, and/or bitstream transmission techniques, which may be employed by a coder system as discussed herein.

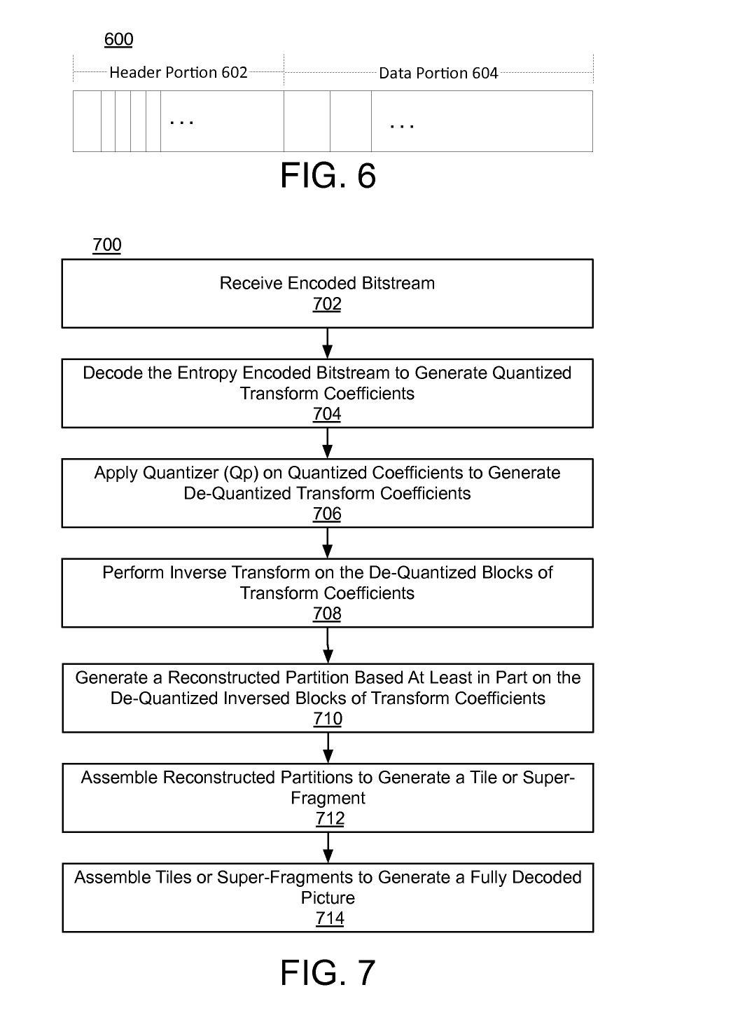

FIG. 6 illustrates an example bitstream 600, arranged in accordance with at least some implementations of the present disclosure. In some examples, bitstream 600 may correspond to bitstream 111 (see, e.g., as shown in FIG. 1) output from coder 100 and/or a corresponding input bitstream to a decoder. Although not shown in FIG. 6 for the sake of clarity of presentation, in some examples bitstream 600 may include a header portion 602 and a data portion 604. In various examples, bitstream 600 may include data, indicators, index values, mode selection data, or the like associated with encoding a video frame as discussed herein. As discussed, bitstream 600 may be generated by an encoder and/or received by a decoder for decoding such that decoded video frames may be presented via a display device.

FIG. 7 is a flow diagram illustrating an example decoding process 700, arranged in accordance with at least some implementations of the present disclosure. Process 700 may include one or more operations, functions or actions as illustrated by one or more of operations 702, etc. Process 700 may form at least part of a video coding process. By way of non-limiting example, process 700 may form at least part of a video decoding process as might be undertaken by the internal decoder loop of coder system 100 of FIG. 1 or a decoder system (not illustrated) of the same or similar design.

Process 700 may begin at operation 702, “Receive Encoded Bitstream”, where a bitstream of a video sequence may be received. For example, a bitstream encoded as discussed herein may be received at a video decoder.

Process 700 may continue at operation 704, “Decode the Entropy Encoded Bitstream to Generate Quantized Transform Coefficients”, where the bitstream may be decoded to generate quantized transform coefficients. In some examples, the decoded data may include to coding partition indicators, block size data, transform type data, quantizer (Qp), quantized transform coefficients, the like, and/or combinations thereof.

Process 700 may continue at operation 706, “Apply Quantizer (Qp) on Quantized Coefficients to Generate a De-Quantized Block of Transform Coefficients”, where a quantizer (Qp) may be applied to quantized transform coefficients to generate a de-quantized block of transform coefficients.

Process 700 may continue at operation 708, “Perform Inverse Transform On the De-Quantized Blocks of Transform Coefficients”, where, an inverse transform may be performed on each de-quantized block of transform coefficients. For example, performing the inverse transform may include an inverse transform process similar to or the same as the inverse of any forward transform used for encoding as discussed herein.

Process 700 may continue at operation 710, “Generate a Reconstructed Partition based at least in part on the De-Quantized and Inversed Blocks of Transform Coefficients”, where a reconstructed prediction partition may be generated based at least in part on the de-quantized and inversed block of transform coefficients. For example, a prediction partition may be added to the decoded prediction error data partition, which is represented by a given de-quantized and inversed block of transform coefficients, to generate a reconstructed prediction partition.

Process 700 may continue at operation 712, “Assemble Reconstructed Partitions to Generate a Tile or Super-Fragment”, where the reconstructed prediction partitions may be assembled to generate a tile or super-fragment. For example, the reconstructed prediction partitions may be assembled to generate tiles or super-fragments.

Process 700 may continue at operation 714, “Assemble Tiles or Super-Fragments Generate a Fully Decoded Picture”, where the tiles or super-fragments of a picture may be assembled (and/or further processed) to generate a fully decoded picture. For example, after optional filtering (e.g., deblock filtering, quality restoration filtering, and/or the like), tiles or super-fragments may be assembled to generate a full decoded picture, which may be stored via a decoded picture buffer (not shown) and/or transmitted for presentment via a display device after picture reorganization.

In operation, the de-quantization may be performed by de-quantization and inverse transform module 110 of FIG. 1, and/or by a similar or identical module in a decoder with structure corresponding to the internal decoder loop of coder system 100 of FIG. 1. Similarly, in some implementations, the inverse transform of Process 700 may be performed by de-quantization and inverse transform module 110 of FIG. 1, and/or by a similar or identical module in a decoder with structure corresponding to the internal decoder loop of coder system 100 of FIG. 1. Those skilled in the art may recognize that de-quantization is achieved by scaling and saturation of the quantized transform coefficients output by 704 in FIG. 7; the inverse transformation process acting on the de-quantized data may be similar to the forward transformation of 108 in operation but with a different transformation matrix.

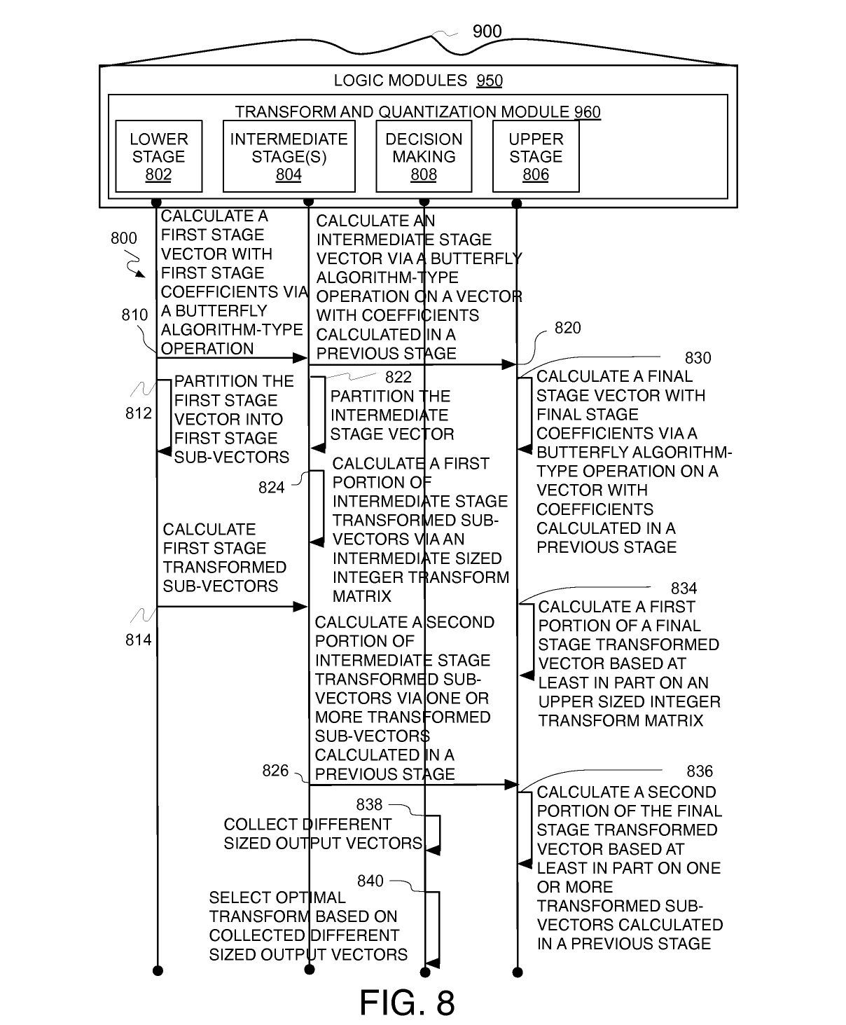

Some additional and/or alternative details related to process 500, 700 and other processes discussed herein may be illustrated in one or more examples of implementations discussed herein and, in particular, with respect to FIG. 8 below.

FIG. 8 provide an illustrative diagram of an example video coding system 900 (see, e.g., FIG. 9 for more details) and video coding process 800 in operation, arranged in accordance with at least some implementations of the present disclosure. In the illustrated implementation, process 800 may include one or more operations, functions or actions as illustrated by one or more of actions 810, etc.

By way of non-limiting example, process 800 will be described herein with reference to example video coding system 900 including coder 100 of FIG. 1, as is discussed further herein below with respect to FIG. 9. In various examples, process 800 may be undertaken by a system including both an encoder and decoder or by separate systems with one system employing an encoder (and optionally a decoder) and another system employing a decoder (and optionally an encoder). It is also noted, as discussed above, that an encoder may include a local decode loop employing a local decoder as a part of the encoder system.

As illustrated, video coding system 900 (see, e.g., FIG. 9 for more details) may include logic modules 950. For example, logic modules 950 may include any modules as discussed with respect to any of the coder systems or subsystems described herein. For example, logic modules 950 may include a transform and quantization logic module 960 and/or the like. For example, transform and quantization logic module 960 may be configured to implement a stage-interdependent multi-stage butterfly integer transform.

Process 800 may begin at operation 810, “CALCULATE A FIRST STAGE VECTOR WITH FIRST STAGE COEFFICIENTS VIA A BUTTERFLY ALGORITHM-TYPE OPERATION”, where a first stage vector with first stage coefficients may be calculated. For example, a first stage vector with first stage coefficients may be calculated based at least in part on a butterfly algorithm-type operation on an input vector of length N with input coefficients.

Process 800 may continue at operation 812, “PARTITION THE FIRST STAGE VECTOR INTO FIRST STAGE SUB-VECTORS”, where, the first stage vector may be partitioned. For example, the first stage vector may be partitioned into first stage sub-vectors.

Process 800 may continue at operation 814, “CALCULATE FIRST STAGE TRANSFORMED SUB-VECTORS”, where first stage transformed sub-vectors may be calculated. For example, first stage transformed sub-vectors may be calculated based at least in part on a lower sized integer transform matrix operating on the first stage sub-vectors.

In some implementations, some or all of operations 810-814 may be considered as occurring in a first stage, which may be followed by one or more similar stages, as will be described below. For example, such a first stage of operations 810-814 may be followed by one or more intermediate stages, and/or a final stage following the one or more intermediate stages. The one or more intermediate stages may be illustrated below as including some or all of operations 820-826. The final stage may be illustrated below as including some or all of operations 830-836.

Process 800 may proceed from operation 810 to continue at operation 820, “CALCULATE AN INTERMEDIATE STAGE VECTOR VIA A BUTTERFLY ALGORITHM-TYPE OPERATION ON A VECTOR WITH COEFFICIENTS CALCULATED IN A PREVIOUS STAGE”, where an intermediate stage vector with intermediate stage type coefficients may be calculated. For example, an intermediate stage vector with intermediate stage type coefficients may be calculated based at least in part on a butterfly algorithm-type operation on a vector with coefficients calculated in a previous stage (e.g., a vector with coefficients calculated at operation 810).

Process 800 may continue at operation 822, “PARTITION THE INTERMEDIATE STAGE VECTOR”, where the intermediate stage vector may be partitioned. For example, the intermediate stage vector may be partitioned into intermediate stage sub-vectors.

Process 800 may continue at operation 824, “CALCULATE A FIRST PORTION OF INTERMEDIATE STAGE TRANSFORMED SUB-VECTORS VIA AN INTERMEDIATE SIZED INTEGER TRANSFORM MATRIX”, where a first portion of intermediate stage transformed sub-vectors may be calculated. For example, a first portion of intermediate stage transformed sub-vectors may be calculated based at least in part on an intermediate sized integer transform matrix operating on the intermediate stage sub-vectors.

Process 800 may continue at operation 826, “CALCULATE A SECOND PORTION OF INTERMEDIATE STAGE TRANSFORMED SUB-VECTORS VIA ONE OR MORE TRANSFORMED SUB-VECTORS CALCULATED IN A PREVIOUS STAGE”, where a second portion of intermediate stage transformed sub-vectors may be calculated. For example, calculating a second portion of the intermediate stage transformed sub-vectors may be calculated based at least in part on one or more transformed sub-vectors calculated in a previous stage (e.g., a transformed sub-vectors calculated at operation 814).

Process 800 may proceed from operation 820 to continue at operation 830, “CALCULATE A FINAL STAGE VECTOR WITH FINAL STAGE COEFFICIENTS VIA A BUTTERFLY ALGORITHM-TYPE OPERATION ON A VECTOR WITH COEFFICIENTS CALCULATED IN A PREVIOUS STAGE”, where a final stage vector with final stage coefficients may be calculated. For example, a final stage vector with final stage coefficients may be calculated based at least in part on a butterfly algorithm-type operation on a vector with coefficients calculated in a previous stage (e.g., a vector with coefficients calculated at operation 820).

Process 800 may continue at operation 834, “CALCULATE A FIRST PORTION OF A FINAL STAGE TRANSFORMED VECTOR BASED AT LEAST IN PART ON AN UPPER SIZED INTEGER TRANSFORM MATRIX”, where a first portion of a final stage transformed vector may be calculated. For example a first portion of a final stage transformed vector may be calculated based at least in part on an upper sized integer transform matrix operating on the final stage vector.

Process 800 may continue at operation 836, “CALCULATE A SECOND PORTION OF THE FINAL STAGE TRANSFORMED VECTOR BASED AT LEAST IN PART ON ONE OR MORE TRANSFORMED SUB-VECTORS CALCULATED IN A PREVIOUS STAGE”, where a second portion of the final stage transformed vector may be calculated. For example, a second portion of the final stage transformed vector may be calculated based at least in part on one or more transformed sub-vectors calculated in a previous stage (e.g., a transformed sub-vectors calculated calculated at operation 826 and/or at operation 824).

Process 800 may continue at operation 838, “COLLECT DIFFERENT SIZED OUTPUT VECTORS”, where different sized output vectors may be collected. For example, different sized output vectors may be collected from various stages (e.g., the different sized transformed vectors output by lower stage 802, intermediate stage(s) 804, and/or final stage 806). In some implementations, operation 838 may collect different sized output vectors from operations 814, 824, 826, 834 and/or 836.

Process 800 may continue at operation 840, “SELECT OPTIMAL TRANSFORM FROM COLLECTED DIFFERENT SIZED OUTPUT VECTORS”, where an optimal transform size may be selected from the collected different sized output vectors. For example, an optimal transform size may be selected from the collected different sized output vectors from various stages (e.g., the different sized transformed vectors output by lower stage 802, intermediate stage(s) 804, and/or final stage 806).

In the illustrated example, the transform and quantization module 960 in FIG. 8 may contain a decision making block 808. For example, decision making block 808 may collect the different sized transformed vectors output by lower stage 802, intermediate stage(s) 804, and/or final stage 806 and may determine optimal sized transform to be used. Alternatively, such operations may be performed as two sub-blocks e.g., a first sub-block including stage interdependent multi-stage butterfly transform logic (e.g., the different sized transformed vectors output by lower stage 802, intermediate stage(s) 804, and/or final stage 806)) and a second sub-block including a “decision making” module 808 that may coexist in encoders and may form part of the bigger transform and quantization module 960.

In operation, on the encoder side, an encoder may partition the frame into Coding Blocks and calculates residuals. At each coding block the encoder may run the proposed algorithm (e.g., process 500 and/or 800) to get the transformed matrices of different sizes (e.g., 4×4, 8×8, 16×16, 32×32). Decision making block 808 may then decide the optimal transformation size for each coding block using these different sized transformed matrices. The optimally chosen transform matrix size termed as “Transform Block” size may then be entropy encoded in the bit stream. The transformed matrices at each Coding Block maybe quantized and embedded in the entropy encoded bitstream. On the decoder side, a decoder may first de-quantizes the quantized data, where the Transform Unit sizes present in the bit stream may be retrieved. Inverse transformation may be performed with these Transform Block sizes on the dequantized data. In such an example, the optimal transformation size has already been decided by the encoder; accordingly, the decoder only has to know this size from the bit stream to perform inverse transformation. The residuals may be obtained, and reconstruction may then be performed by the decoder.

In some implementations, the lower sized integer transform matrix and one or more intermediate sized integer transform matrixes may be subsampled versions of the upper sized integer transform matrix. Similarly, the lower sized integer transform matrix may be a subsampled version of the upper sized integer transform matrix as well as a subsampled version of the one or more intermediate sized integer transform matrixes.

In some implementations, the lower sized integer transform matrix, the one or more intermediate sized integer transform matrix, and the upper sized transform matrix may all be at least partially symmetric.

In some implementations, the number of first stage transformed sub-vectors output from the first stage may be higher than the number of intermediate stage transformed sub-vectors output from one of the intermediate stages, while the size of the first stage integer transform matrix may be smaller than the size of the intermediate stage integer transform matrix.

Although process 800, as illustrated, is directed to coding, the concepts and/or operations described may be applied to encoding and/or decoding separately, and, more generally, to video coding.

While implementation of the example processes herein may include the undertaking of all operations shown in the order illustrated, the present disclosure is not limited in this regard and, in various examples, implementation of the example processes herein may include the undertaking of only a subset of the operations shown and/or in a different order than illustrated. Additionally, although one particular set of blocks or actions is illustrated as being associated with particular modules, these blocks or actions may be associated with different modules than the particular modules illustrated here.

Various components of the systems and/or processes described herein may be implemented in software, firmware, and/or hardware and/or any combination thereof. For example, various components of the systems and/or processes described herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures.

As used in any implementation described herein, the term “module” may refer to a “component” or to a “logic unit”, as these terms are described below. Accordingly, the term “module” may refer to any combination of software logic, firmware logic, and/or hardware logic configured to provide the functionality described herein. For example, one of ordinary skill in the art will appreciate that operations performed by hardware and/or firmware may alternatively be implemented via a software component, which may be embodied as a software package, code and/or instruction set, and also appreciate that a logic unit may also utilize a portion of software to implement its functionality.

As used in any implementation described herein, the term “component” refers to any combination of software logic and/or firmware logic configured to provide the functionality described herein. The software logic may be embodied as a software package, code and/or instruction set, and/or firmware that stores instructions executed by programmable circuitry. The components may, collectively or individually, be embodied for implementation as part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the systems discussed herein. Further, one of ordinary skill in the art will appreciate that operations performed by hardware and/or firmware may also utilize a portion of software to implement the functionality of the logic unit.

In addition, any one or more of the blocks of the processes described herein may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5, 6, and 8 in response to instructions conveyed to the processor by a computer readable medium.

FIG. 9 is an illustrative diagram of example video coding system 900, arranged in accordance with at least some implementations of the present disclosure. In the illustrated implementation, video coding system 900, although illustrated with both video encoder 902 and video decoder 904, video coding system 900 may include only video encoder 902 or only video decoder 904 in various examples. Video coding system 900 (which may include only video encoder 902 or only video decoder 904 in various examples) may include imaging device(s) 901, an antenna 902, one or more processor(s) 906, one or more memory store(s) 908, and/or a display device 910. As illustrated, imaging device(s) 901, antenna 902, video encoder 902, video decoder 904, processor(s) 906, memory store(s) 908, and/or display device 910 may be capable of communication with one another.

In some implementations, video coding system 900 may include antenna 903. For example, antenna 903 may be configured to transmit or receive an encoded bitstream of video data, for example. Processor(s) 906 may be any type of processor and/or processing unit. For example, processor(s) 906 may include distinct central processing units, distinct graphic processing units, integrated system-on-a-chip (SoC) architectures, the like, and/or combinations thereof. In addition, memory store(s) 908 may be any type of memory. For example, memory store(s) 908 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 908 may be implemented by cache memory. Further, in some implementations, video coding system 900 may include display device 910. Display device 910 may be configured to present video data.

As shown, in some examples, video coding system 900 may include logic modules 950. While illustrated as being associated with video decoder 904, video encoder 902 may similarly be associated with identical and/or similar logic modules as the illustrated logic modules 950. Accordingly, video decoder 904 may include all or portions of logic modules 950. For example, antenna 903, video decoder 904, processor(s) 906, memory store(s) 908, and/or display 910 may be capable of communication with one another and/or communication with portions of logic modules 950. Similarly, video encoder 902 may include identical and/or similar logic modules to logic modules 950. For example, imaging device(s) 901 and video encoder 902 may be capable of communication with one another and/or communication with logic modules that are identical and/or similar to logic modules 950.

In some implementations, logic modules 950 may embody various modules as discussed with respect to any system or subsystem described herein. For example, logic modules 950 may include a transform and quantization logic module 960 and/or the like. For example, transform and quantization logic module 960 may be configured to implement a stage-interdependent multi-stage butterfly integer transform.

In some implementations, at a first stage transform and quantization logic module 960 of video encoder 902 may be configured to: calculate a first stage vector with first stage coefficients based at least in part on a butterfly algorithm-type operation on an input vector of length N with input coefficients; partition the first stage vector into first stage sub-vectors; and calculate first stage transformed sub-vectors based at least in part on a lower sized integer transform matrix operating on the first stage sub-vectors. At one or more intermediate stages the transform and quantization logic module 960 may be configure to: calculate an intermediate stage vector with intermediate stage type coefficients based at least in part on a butterfly algorithm-type operation on a vector with coefficients calculated in a previous stage; partition the intermediate stage vector into intermediate stage sub-vectors; and calculate a first portion of intermediate stage transformed sub-vectors based at least in part on an intermediate sized integer transform matrix operating on the intermediate stage sub-vectors.

In various embodiments, some of logic modules 950 may be implemented in hardware, while software may implement other logic modules. For example, in some embodiments, some of logic modules 950 may be implemented by application-specific integrated circuit (ASIC) logic while other logic modules may be provided by software instructions executed by logic such as processors 906. However, the present disclosure is not limited in this regard and some of logic modules 950 may be implemented by any combination of hardware, firmware and/or software.

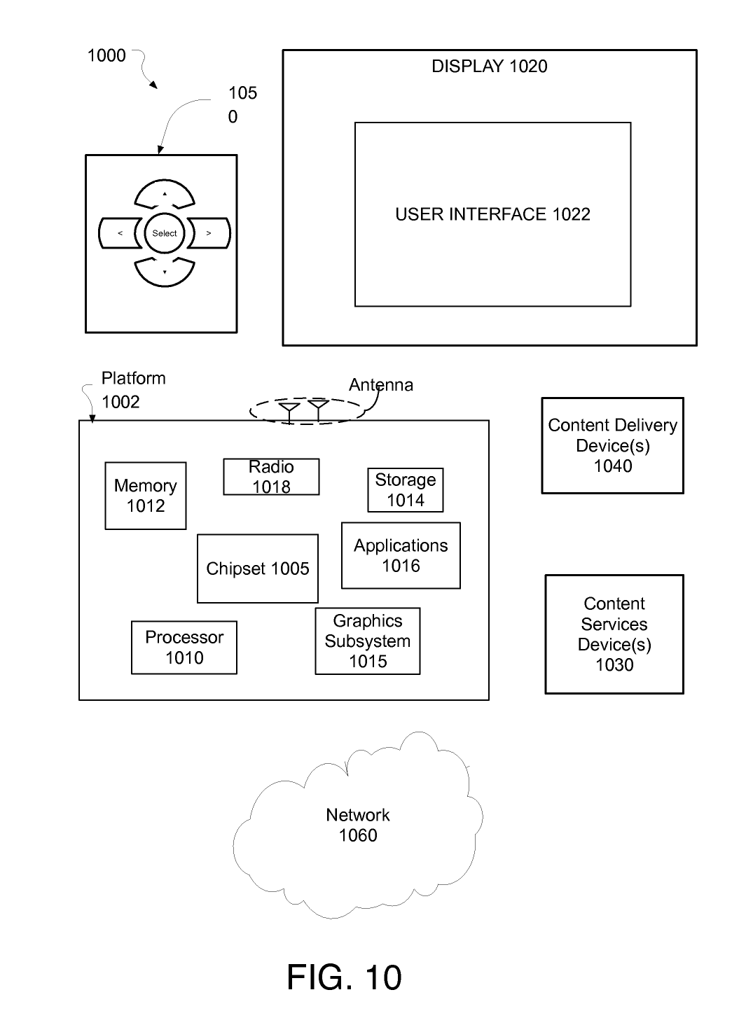

FIG. 10 is an illustrative diagram of an example system 1000, arranged in accordance with at least some implementations of the present disclosure. In various implementations, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1000 includes a platform 1002 coupled to a display 1020. Platform 1002 may receive content from a content device such as content services device(s) 1030 or content delivery device(s) 1040 or other similar content sources. A navigation controller 1050 including one or more navigation features may be used to interact with, for example, platform 1002 and/or display 1020. Each of these components is described in greater detail below.

In various implementations, platform 1002 may include any combination of a chipset 1005, processor 1010, memory 1012, antenna 1013, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1010 may be dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPU) or a visual processing unit (VPU), for example. An analog or digital interface may be used to communicatively couple graphics subsystem 1015 and display 1020. For example, the interface may be any of a High-Definition Multimedia Interface, DisplayPort, wireless HDMI, and/or wireless HD compliant techniques. Graphics subsystem 1015 may be integrated into processor 1010 or chipset 1005. In some implementations, graphics subsystem 1015 may be a stand-alone device communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television type monitor or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In various implementations, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In various implementations, content services device(s) 1030 may include a cable television box, personal computer, network, telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In various embodiments, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be replicated on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022. In various embodiments, controller 1050 may not be a separate component but may be integrated into platform 1002 and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 even when the platform is turned “off.” In addition, chipset 1005 may include hardware and/or software support for (5.1) surround sound audio and/or high definition (7.1) surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 may be an integrated unit. Display 1020 and content service device(s) 1030 may be integrated, or display 1020 and content delivery device(s) 1040 may be integrated, for example. These examples are not meant to limit the present disclosure.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

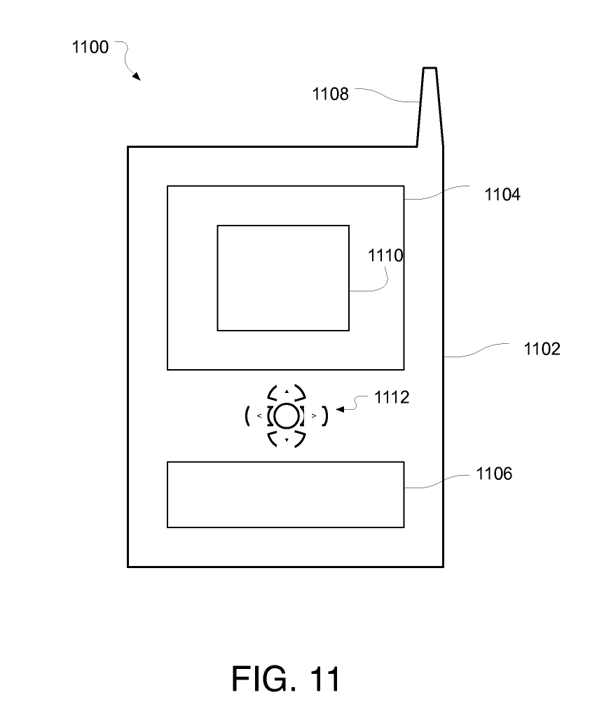

As described above, system 1000 may be embodied in varying physical styles or form factors. FIG. 11 illustrates implementations of a small form factor device 1100 in which system 1100 may be embodied. In various embodiments, for example, device 1100 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internes device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 1100 may include a housing 1102, a display 1104 which may include a user interface 1110, an input/output (I/O) device 1106, and an antenna 1108. Device 1100 also may include navigation features 1112. Display 1104 may include any suitable display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, image sensors, and so forth. Information also may be entered into device 1100 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the systems as discussed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one implementation, a computer-implemented method for video coding may include a stage-interdependent multi-stage butterfly integer transform. At a first stage the stage-interdependent multi-stage butterfly integer transform may: calculate a first stage vector with first stage coefficients based at least in part on a butterfly algorithm-type operation on an input vector of length N with input coefficients; partition the first stage vector into first stage sub-vectors; and calculate first stage transformed sub-vectors based at least in part on a lower sized integer transform matrix operating on the first stage sub-vectors. At one or more intermediate stages the stage-interdependent multi-stage butterfly integer transform may: calculate an intermediate stage vector with intermediate stage type coefficients based at least in part on a butterfly algorithm-type operation on a vector with coefficients calculated in a previous stage; partition the intermediate stage vector into intermediate stage sub-vectors; and calculat a first portion of intermediate stage transformed sub-vectors based at least in part on an intermediate sized integer transform matrix operating on the intermediate stage sub-vectors.

For example, a computer-implemented method for video coding may further include at the one or more intermediate stages the stage-interdependent multi-stage butterfly integer transform may: calculate a second portion of the intermediate stage transformed sub-vectors based at least in part on one or more transformed sub-vectors calculated in a previous stage. At a final stage the stage-interdependent multi-stage butterfly integer transform may: calculate a final stage vector with final stage coefficients based at least in part on a butterfly algorithm-type operation on a vector with coefficients calculated in a previous stage; calculate a first portion of a final stage transformed vector based at least in part on an upper sized integer transform matrix operating on the final stage vector; and calculate a second portion of the final stage transformed vector based at least in part on one or more transformed sub-vectors calculated in a previous stage. The method may also collect two or more different sized output vectors from on or more stages; and select an optimal transform from the collected different sized output vectors. The lower sized integer transform matrix and one or more intermediate sized integer transform matrixes may be subsampled versions of the upper sized integer transform matrix. The lower sized integer transform matrix may be a subsampled version of the upper sized integer transform matrix and a subsampled version of the one or more intermediate sized integer transform matrixes. The lower sized integer transform matrix, the one or more intermediate sized integer transform matrix, and the upper sized transform matrix may all be at least partially symmetric. The number of first stage transformed sub-vectors output from the first stage may be higher than the number of intermediate stage transformed sub-vectors output from one of the intermediate stages, while the size of the first stage integer transform matrix may be smaller than the size of the intermediate stage integer transform matrix.

In other examples, a system for video coding on a computer may include a display device, one or more processors, one or more memory stores, one or more logic modules, the like, and/or combinations thereof. The display device may be configured to present video data. The one or more processors may be communicatively coupled to the display device. The one or more memory stores may be communicatively coupled to the one or more processors. The logic modules may include a transform and quantization logic module of a video coder communicatively coupled to the one or more processors. At a first stage the transform and quantization logic module may be configured to: calculate a first stage vector with first stage coefficients based at least in part on a butterfly algorithm-type operation on an input vector of length N with input coefficients; partition the first stage vector into first stage sub-vectors; and calculate first stage transformed sub-vectors based at least in part on a lower sized integer transform matrix operating on the first stage sub-vectors. At one or more intermediate stages the transform and quantization logic module may be configure to: calculate an intermediate stage vector with intermediate stage type coefficients based at least in part on a butterfly algorithm-type operation on a vector with coefficients calculated in a previous stage; partition the intermediate stage vector into intermediate stage sub-vectors; and calculate a first portion of intermediate stage transformed sub-vectors based at least in part on an intermediate sized integer transform matrix operating on the intermediate stage sub-vectors.

For example, the system for video coding on a computer may further include: at the one or more intermediate stages, the transform and quantization logic module may be further configured to: calculate a second portion of the intermediate stage transformed sub-vectors based at least in part on one or more transformed sub-vectors calculated in a previous stage. At a final stage, the transform and quantization logic module may be further configured to: calculate a final stage vector with final stage coefficients based at least in part on a butterfly algorithm-type operation on a vector with coefficients calculated in a previous stage; calculate a first portion of a final stage transformed vector based at least in part on an upper sized integer transform matrix operating on the final stage vector; and calculate a second portion of the final stage transformed vector based at least in part on one or more transformed sub-vectors calculated in a previous stage. The system may further include a decision making module configured to: collect two or more different sized output vectors from on or more stages; and select an optimal transform from the collected different sized output vectors. The lower sized integer transform matrix and one or more intermediate sized integer transform matrixes may be subsampled versions of the upper sized integer transform matrix. The lower sized integer transform matrix may be a subsampled version of the upper sized integer transform matrix and a subsampled version of the one or more intermediate sized integer transform matrixes. The lower sized integer transform matrix, the one or more intermediate sized integer transform matrix, and the upper sized transform matrix may all be at least partially symmetric. The number of first stage transformed sub-vectors output from the first stage may be higher than the number of intermediate stage transformed sub-vectors output from one of the intermediate stages, while the size of the first stage integer transform matrix may be smaller than the size of the intermediate stage integer transform matrix.

In a further implementation, at least one machine readable medium may include a plurality of instructions that in response to being executed on a computing device, causes the computing device to perform the method according to any one of the above examples.

In a still further implementation, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed:

1. A computer-implemented method for video coding including a stage-interdependent multi-stage butterfly integer transform, comprising:
at a first stage:
calculating a first stage vector with first stage coefficients based at least in part on a butterfly algorithm-type operation on an input vector of length N with input coefficients;
partitioning the first stage vector into first stage sub-vectors;
calculating first stage transformed sub-vectors based at least in part on a lower sized integer transform matrix operating on the first stage sub-vectors;
at one or more intermediate stages:
calculating an intermediate stage vector with intermediate stage type coefficients based at least in part on a butterfly algorithm-type operation on a vector with coefficients calculated in a previous stage;
partitioning the intermediate stage vector into intermediate stage sub-vectors; and
calculating a first portion of intermediate stage transformed sub-vectors based at least in part on an intermediate sized integer transform matrix operating on the intermediate stage sub-vectors.

2. The method of claim 1, wherein the one or more intermediate stages further includes:
calculating a second portion of the intermediate stage transformed sub-vectors based at least in part on one or more transformed sub-vectors calculated in a previous stage.

3. The method of claim 1, the method further comprising:
at a final stage:
calculating a final stage vector with final stage coefficients based at least in part on a butterfly algorithm-type operation on a vector with coefficients calculated in a previous stage; and
calculating a first portion of a final stage transformed vector based at least in part on an upper sized integer transform matrix operating on the final stage vector.

4. The method of claim 1, the method further comprising:
at a final stage:
calculating a final stage vector with final stage coefficients based at least in part on a butterfly algorithm-type operation on a vector with coefficients calculated in a previous stage;
calculating a first portion of a final stage transformed vector based at least in part on an upper sized integer transform matrix operating on the final stage vector; and
calculating a second portion of the final stage transformed vector based at least in part on one or more transformed sub-vectors calculated in a previous stage.

5. The method of claim 1, wherein the lower sized integer transform matrix and the one or more intermediate sized integer transform matrixes are subsampled versions of an upper sized integer transform matrix.

6. The method of claim 1, wherein the lower sized integer transform matrix is a subsampled version of an upper sized integer transform matrix and a subsampled version of the one or more intermediate sized integer transform matrixes.

7. The method of claim 1, wherein the lower sized integer transform matrix, the one or more intermediate sized integer transform matrix, and an upper sized transform matrix are all at least partially symmetric.

8. The method of claim 1, wherein the number of first stage transformed sub-vectors output from the first stage is higher than the number of intermediate stage transformed sub-vectors output from one of the intermediate stages.

9. The method of claim 1, wherein the size of the first stage integer transform matrix is smaller than the size of the intermediate stage integer transform matrix.

10. The method of claim 1, further comprising:
collecting two or more different sized output vectors from on or more stages; and
selecting an optimal transform from the collected different sized output vectors.

11. The method of claim 1, the method further comprising:
at the one or more intermediate stages:
calculating a second portion of the intermediate stage transformed sub-vectors based at least in part on one or more transformed sub-vectors calculated in a previous stage;
at a final stage:
calculating a final stage vector with final stage coefficients based at least in part on a butterfly algorithm-type operation on a vector with coefficients calculated in a previous stage;
calculating a first portion of a final stage transformed vector based at least in part on an upper sized integer transform matrix operating on the final stage vector;
calculating a second portion of the final stage transformed vector based at least in part on one or more transformed sub-vectors calculated in a previous stage,
collecting two or more different sized output vectors from on or more stages; and
selecting an optimal transform from the collected different sized output vectors,
wherein the lower sized integer transform matrix and one or more intermediate sized integer transform matrixes are subsampled versions of the upper sized integer transform matrix,
wherein the lower sized integer transform matrix is a subsampled version of the upper sized integer transform matrix and a subsampled version of the one or more intermediate sized integer transform matrixes,
wherein the lower sized integer transform matrix, the one or more intermediate sized integer transform matrix, and the upper sized transform matrix are all at least partially symmetric,
wherein the number of first stage transformed sub-vectors output from the first stage is higher than the number of intermediate stage transformed sub-vectors output from one of the intermediate stages, while the size of the first stage integer transform matrix is smaller than the size of the intermediate stage integer transform matrix.

12. A system for video coding on a computer, comprising:
a display device configured to present video data;
one or more processors communicatively coupled to the display device;
one or more memory stores communicatively coupled to the one or more processors;
a transform and quantization logic module of a video coder communicatively coupled to the one or more processors and configured to:
at a first stage:
calculate a first stage vector with first stage coefficients based at least in part on a butterfly algorithm-type operation on an input vector of length N with input coefficients;
partition the first stage vector into first stage sub-vectors;
calculate first stage transformed sub-vectors based at least in part on a lower sized integer transform matrix operating on the first stage sub-vectors;
at one or more intermediate stages:
calculate an intermediate stage vector with intermediate stage type coefficients based at least in part on a butterfly algorithm-type operation on a vector with coefficients calculated in a previous stage;
partition the intermediate stage vector into intermediate stage sub-vectors; and
calculate a first portion of intermediate stage transformed sub-vectors based at least in part on an intermediate sized integer transform matrix operating on the intermediate stage sub-vectors.

13. The system of claim 12, wherein the one or more intermediate stages further includes the transform and quantization logic module being further configured to:
calculate a second portion of the intermediate stage transformed sub-vectors based at least in part on one or more transformed sub-vectors calculated in a previous stage.

14. The system of claim 12, wherein the transform and quantization logic module is further configured to:
at a final stage:
calculate a final stage vector with final stage coefficients based at least in part on a butterfly algorithm-type operation on a vector with coefficients calculated in a previous stage; and
calculate a first portion of a final stage transformed vector based at least in part on an upper sized integer transform matrix operating on the final stage vector.

15. The system of claim 12, wherein the transform and quantization logic module is further configured to:
at a final stage:
calculate a final stage vector with final stage coefficients based at least in part on a butterfly algorithm-type operation on a vector with coefficients calculated in a previous stage;
calculate a first portion of a final stage transformed vector based at least in part on an upper sized integer transform matrix operating on the final stage vector; and
calculate a second portion of the final stage transformed vector based at least in part on one or more transformed sub-vectors calculated in a previous stage.

16. The system of claim 12, wherein the lower sized integer transform matrix and the one or more intermediate sized integer transform matrixes are subsampled versions of an upper sized integer transform matrix.

17. The system of claim 12, wherein the lower sized integer transform matrix, the one or more intermediate sized integer transform matrix, and an upper sized transform matrix are all at least partially symmetric.

18. The system of claim 12, further comprising a decision making module, the decision making module being configured to:
collect two or more different sized output vectors from on or more stages; and
select an optimal transform from the collected different sized output vectors.

19. The system of claim 12, further comprising:
at the one or more intermediate stages, the transform and quantization logic module is further configured to:
calculate a second portion of the intermediate stage transformed sub-vectors based at least in part on one or more transformed sub-vectors calculated in a previous stage;
at a final stage, the transform and quantization logic module is further configured to:
calculate a final stage vector with final stage coefficients based at least in part on a butterfly algorithm-type operation on a vector with coefficients calculated in a previous stage;
calculate a first portion of a final stage transformed vector based at least in part on an upper sized integer transform matrix operating on the final stage vector;
calculate a second portion of the final stage transformed vector based at least in part on one or more transformed sub-vectors calculated in a previous stage,
further comprising a decision making module, the decision making module being configured to: collect two or more different sized output vectors from on or more stages; and select an optimal transform from the collected different sized output vectors,
wherein the lower sized integer transform matrix and one or more intermediate sized integer transform matrixes are subsampled versions of the upper sized integer transform matrix,
wherein the lower sized integer transform matrix is a subsampled version of the upper sized integer transform matrix and a subsampled version of the one or more intermediate sized integer transform matrixes,
wherein the lower sized integer transform matrix, the one or more intermediate sized integer transform matrix, and the upper sized transform matrix are all at least partially symmetric,
wherein the number of first stage transformed sub-vectors output from the first stage is higher than the number of intermediate stage transformed sub-vectors output from one of the intermediate stages, while the size of the first stage integer transform matrix is smaller than the size of the intermediate stage integer transform matrix.

20. At least one machine readable medium comprising: a plurality of instructions that in response to being executed on a computing device, causes the computing device to perform:
at a first stage:
calculate a first stage vector with first stage coefficients based at least in part on a butterfly algorithm-type operation on an input vector of length N with input coefficients;
partition the first stage vector into first stage sub-vectors;
calculate first stage transformed sub-vectors based at least in part on a lower sized integer transform matrix operating on the first stage sub-vectors;
at one or more intermediate stages:
calculate an intermediate stage vector with intermediate stage type coefficients based at least in part on a butterfly algorithm-type operation on a vector with coefficients calculated in a previous stage;
partition the intermediate stage vector into intermediate stage sub-vectors; and
calculate a first portion of intermediate stage transformed sub-vectors based at least in part on an intermediate sized integer transform matrix operating on the intermediate stage sub-vectors.

21. The at least one machine readable medium method of claim 20, further comprising:
at the one or more intermediate stages:
calculate a second portion of the intermediate stage transformed sub-vectors based at least in part on one or more transformed sub-vectors calculated in a previous stage;
at a final stage:
calculate a final stage vector with final stage coefficients based at least in part on a butterfly algorithm-type operation on a vector with coefficients calculated in a previous stage;
calculate a first portion of a final stage transformed vector based at least in part on an upper sized integer transform matrix operating on the final stage vector;
calculate a second portion of the final stage transformed vector based at least in part on one or more transformed sub-vectors calculated in a previous stage,
collect two or more different sized output vectors from on or more stages; and
select an optimal transform from the collected different sized output vectors,
wherein the lower sized integer transform matrix and one or more intermediate sized integer transform matrixes are subsampled versions of the upper sized integer transform matrix,
wherein the lower sized integer transform matrix is a subsampled version of the upper sized integer transform matrix and a subsampled version of the one or more intermediate sized integer transform matrixes,
wherein the lower sized integer transform matrix, the one or more intermediate sized integer transform matrix, and the upper sized transform matrix are all at least partially symmetric,
wherein the number of first stage transformed sub-vectors output from the first stage is higher than the number of intermediate stage transformed sub-vectors output from one of the intermediate stages, while the size of the first stage integer transform matrix is smaller than the size of the intermediate stage integer transform matrix.
